(19) United States
(12) Patent Application Publication
(10) Pub. No.: US 2002/0135214 A1
(43) Pub. Date: Sep. 26, 2002

(54) Device for displacing a vehicle seat

(76) Inventors: Eckhard Ursel, Buehl (DE); Gerhard Genter, Achern (DE); Manfred Winter, Lichtenau (DE); Walter Haussecker, Buehlertal (DE); Herbert Schiller, Buehlertal (DE); Erik Maenle, Oberkirch (DE); Guenter Hartz, Buehlertal (DE); Joerg Wolf, Karlsruhe (DE); Werner Prohaska, Ottersweier (DE); Martin Steuer, Buehlertal (DE); Hansjuergen Linde, Coburg (DE); Uwe Neumann, Bamberg (DE); Andreas Rehlau, Coburg (DE); Dieter Scheer, Fisch (DE)

Correspondence Address: Striker Striker & Stenby, 103 East Neck Road, Huntington, NY, 11743, US

(21) Appl. No.: 10/018,652

(22) PCT Filed: Apr. 4, 2001
(86) PCT No.: PCT/DE01/01306

(30) Foreign Application Priority Data
Apr. 18, 2000 (DE) 100 19 218.1

(51) Int. Cl. B60N 2/10

(52) U.S. Cl. 297/330; 297/325

(57) ABSTRACT

The invention is based on an apparatus for adjusting a vehicle seat, the position of which can be adjusted via one or more geared motors (8, 38, 41, 42), wherein the geared motors (8, 38, 41, 42) can be actuated via a control (24). A vehicle seat underbody (3, 32, 45) is supported at at least three points by means of driven lifting spindles (16), driven guide bars (28, 39, 40) or sliding fixtures (34, 35, 43), wherein at least one support point (16, 29, 34) can be varied relative to the other remaining support points of the vehicle seat in such a fashion that a spherical seat adjustment results.

### TECHNICAL FIELD

In general, passengers in motor vehicles can only adjust their seat position in motor vehicles statically in advance. The seat position is usually not adjusted during the ride, and the seat position of the vehicle passengers does not adapt to the driving situations that occur.

### PRIOR ART

In motor vehicle systems that are known to date and are common today, the vehicle passengers individually select the seat position in the vehicle before the drive that is most favorable to them and that feels the most comfortable. During the ride, the vehicle passengers are generally subjected to transverse forces resulting from lateral acceleration, e.g., when driving around curves. Moreover, transverse forces occur that are produced in braking and deceleration phases when the motor vehicle is driven. During the ride, transverse strains occur between the upholstery of the vehicle seats and the vehicle passengers due to the dynamic forces produced that depend on the driving situation and that affect the passengers, which transverse strains can be perceived by the vehicle passengers as very uncomfortable. This applies in particular when the level of the transverse strains exceeds the upper threshold value perceived as personally acceptable by the respective vehicle passenger.

### PRESENTATION OF THE INVENTION

Using the means of attaining the object of the invention proposed according to the invention, a spherical adjustment of a vehicle seat can be achieved that adjusts to the respective driving situation of the vehicle in such a fashion that lateral acceleration forces and transverse forces affecting the person who is seated on the vehicle seat are minimized.

According to a variant of the embodiment of a spherical adjusting mechanism for vehicle seats, a frame-shaped profile supporting the seat surfaces is supported by four individually-controllable lifting spindle geared motors. In the zero position of the lifting spindle position, the lifting spindles are parallel to each other. With this selected arrangement on the underside of the vehicle seat underbody, an additional height adjusting apparatus can be eliminated. The vehicle seat can also be tilted around its longitudinal axis, like a pitching motion around its transversal axis.

According to a further variant, the seat surface of a vehicle seat is supported in four guide bars, wherein two four-bar mechanisms standing at a slant to each other can be formed. The four-bar mechanisms form a trapezoidal arrangement in relation to each other, so that the instantaneous center of a lateral tilting motion as well as a movement of the vehicle seat toward the front and toward the back can be determined individually. In this variant of the embodiment, the instantaneous center is located at a clear distance above the seat surface. In this variant of the embodiment, it is particularly advantageous that an axis of rotation of the seat occurs that is located above the center of gravity of the individual. If a crash occurs, the person is pushed into a position that counteracts the direction of the crash, so that the seat-including the person sitting on it-is protected against the effects of such an event.

In a further variant of the embodiment of a spherical adjusting mechanism of a vehicle seat, an element designed in the shape of a ball cup is used as an adjusting pivoted link. The element designed in the shape of a ball cup is supported by 3 or 4 sliding cushions that are supported in receptacles on side rails of the seat. A friction-improving sliding behavior is effected between the element designed in the shape of a ball cup and the sliding cushions due to improved friction partners.

In this configuration, the seat can be adjusted using only one adjusting unit, and the seat can be tilted around its longitudinal axis as well as around its transverse axis. No guide bars or joints connecting them are needed in this variant of the embodiment. Furthermore, a defined, fixed rotation point of the vehicle seat can be identified. The ball socket can be adjusted by means of guide bars and adjusting geared motors at the seat bucket, which then rotates in this point.

Finally, the embodiment of a spherical vehicle seat adjustment having two rigid guide bars and a movable third guide bar is possible. The two rigid guide bars are provided in the rear section of the seat surface of the vehicle seat, while the movable third guide bar is located in a lower position in the front section of the seat surface. As a result, the center of rotation in the front section of the seat occurs at a markedly lower point than in the rear section of the seat, whereby the momentary axis of rotation forms as slanting from the middle seat back height, i.e., in the intersection of the axes of the two rear rigid guide bars up to the anterior point of rotation in the seat cushion. As a result of the slanted axis of rotation, when the seat is adjusted laterally, it is also forced into a supporting rotation around the vertical axis. Two adjusting drives are used to actuate the guide bars in this configuration.

In a further variant, a vehicle seat is secured to a seat underbody accommodated at a slant. Building on the spherical adjustment using four rigid guide bars—as described above—the adjustment of the vehicle seat around the transverse axis is prevented in this variant. The available guide bar geometry is used for height adjustment. In so doing, the two five-bar mechanisms standing parallel to each other are tilted toward their longitudinal axis in such a fashion that the intersection of the plane mechanisms-now standing at a slant relative to each other—is located in an instantaneous center line above the seat surface.

In a final variant of the embodiment, a seat underbody having a central force transduction located inside the guide rails accommodating the seat is feasible. By means of the central arrangement of force transduction in the middle of the vehicle seat underbody, the the lifting spindle geared motors accommodated on the four corners can be relieved, so that no noise is produced by play that occurs, and the lifting spindle geared motors are basically relieved of the weight of the vehicle seat and the individual seated on the seat.

### DRAWING

The invention will be described in greater detail hereinafter using the drawing.

FIG. 1 is a vehicle seat underbody according to the 4-column principle

FIG. 2 is the sliding rail frame profile that is provided with bracings extending on the sides and that strengthen the structure,

FIG. 3 is a partial sectional view of a lifting spindle motor with support and frame profile,

FIG. 4 is a wiring diagram for the control of four geared motors that are assigned to support points of a vehicle seat underbody,

FIG. 5 is a spherical seat adjustment with four rigid guide bars and a common adjusting drive,

FIG. 6 is a representation of the instantaneous center occurring for the spherical seat adjustment according to FIG. 5,

FIG. 7 is a spherical seat adjustment with ball cup designed in the form of a pivoted link, supported in sliding cushions, and accommodating the vehicle seat,

FIG. 8 is a spherical seat adjustment with two steel guide bars in the rear section of the vehicle seat and a third movable guide bar in the front section,

FIG. 9 is a spherical seat adjustment having three steel guide bars,

FIG. 10 is a spherical seat adjustment with seat underbody hung at a slant,

FIG. 11 is the representation of a spherical seat adjustment having a ball joint segment lying on receptacles accommodated on seat rails, and

FIG. 12 is a spherical adjustment of a vehicle seat underbody having 4 columns, wherein a central force transduction is indicated in the middle of the underbody.

### VARIANTS OF THE EMBODIMENT

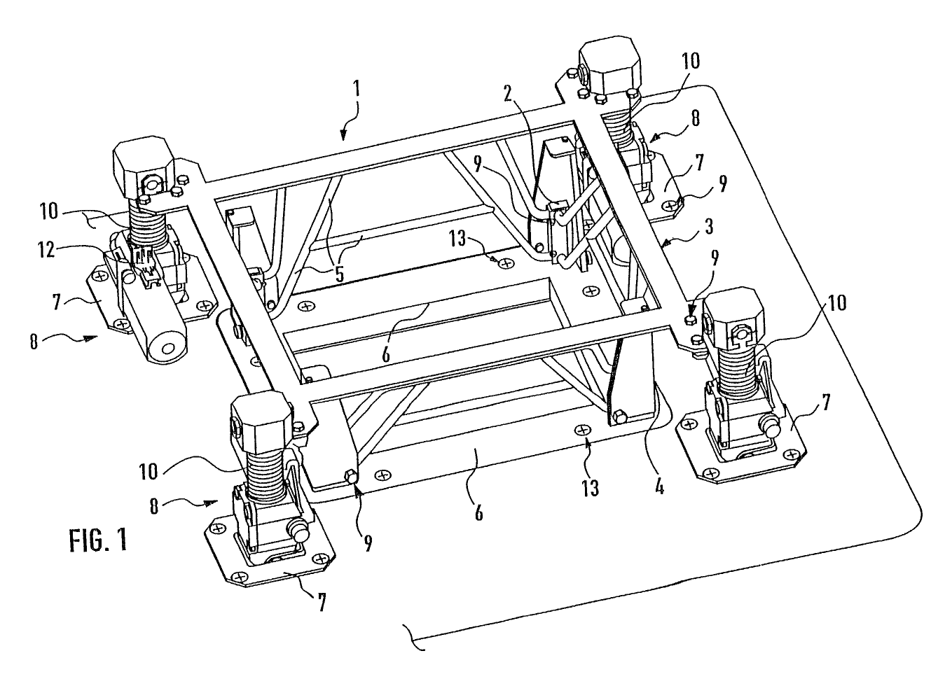

FIG. 1 shows a vehicle seat underbody based on the 4-column principle.

In this configuration of a spherical seat adjustment 1, a rectangular frame profile is provided as sliding pad holder 3, on which individual sliding pads 2 are formed. The sliding pad holder 3 is strengthened by means of a bracing 5 in order to withstand the stresses caused by the weight of the vehicle seat underbody and the person sitting on the vehicle seat at that time.

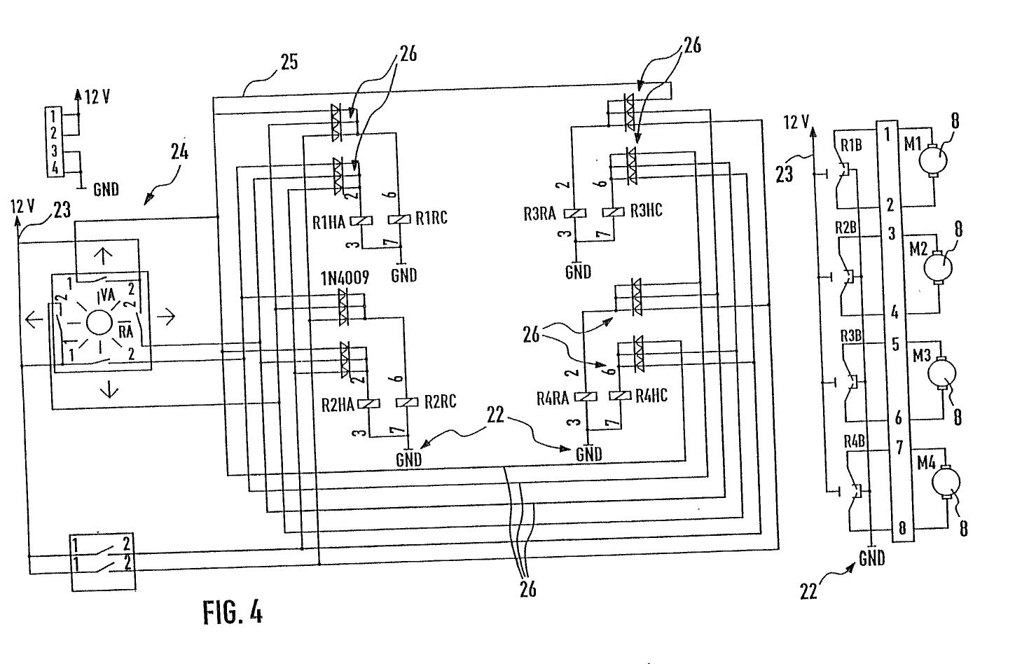

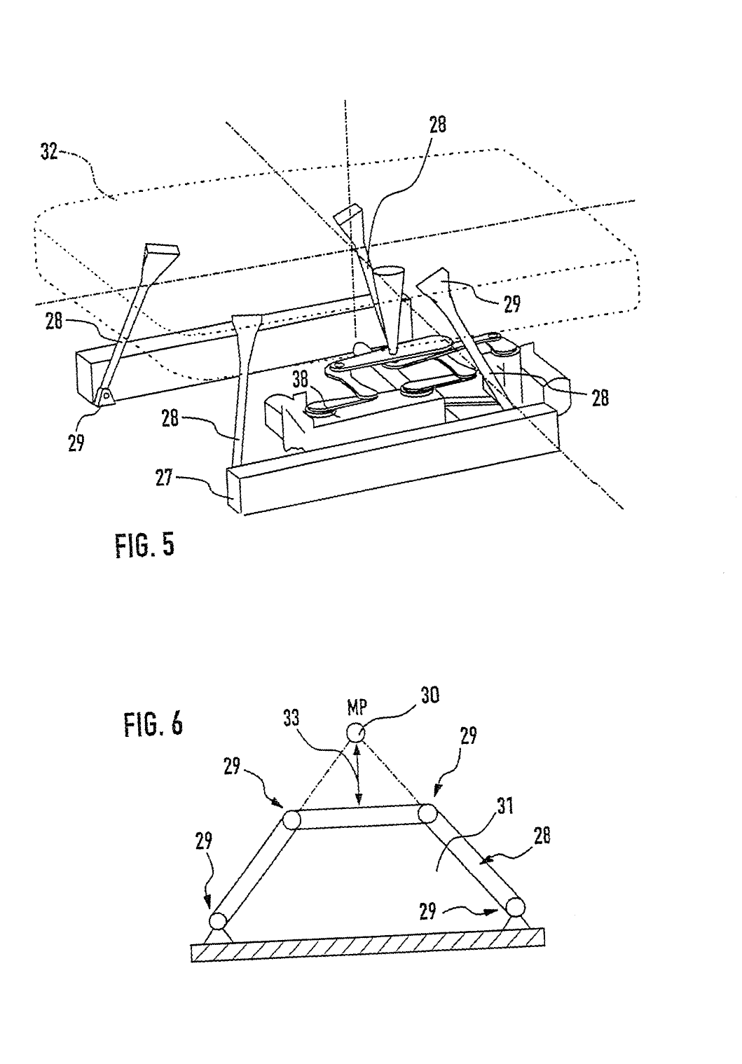

The sliding pads 2 formed on the sliding pad holder 3 are enclosed by sliding pad guides 4. The sliding pad guides 4 are provided with a stop 11 on the top end, in order to prevent the sliding pads 2 from leaving the sliding pad guides 4 enclosing them. The sliding pad guides 4 are accommodated on a base plate 6 that represents the floor of the passenger compartment of a motor vehicle, for example. Base plates 7 are assigned to the corner points of the base plate 6, connected to the vehicle floor by means of screwed connections 13, each of which accommodates a lifting spindle geared motor 8 with which the sliding pad holder 3 can be moved. The motion can take place around the longitudinal axis of a seat surface 32 (refer to FIG. 5), or, if the geared motor 8 is controlled accordingly by a control 24 (refer to FIG. 4), it can also take place around the transversal axis of the vehicle seat, representing a tilting motion. The geared motors 8, which make the spherical adjustment of the vehicle seat possible, are connected to the base plate 7 of the vehicle floor via screwed connections 9, and to the sliding pad holder 3 via screwed connections 9.

The geared motors 8 contain a spindle drive, whereby the spindles can be enclosed in spring elements 10 to support the upward motion and to relieve the meshing gear components, as shown in FIG. 1. The spring elements 10 cover the spindles driven by the geared motors 8. Electrical terminals are provided at each of the geared motors 8, with which the geared motors 8 are connected to a power supply 23.

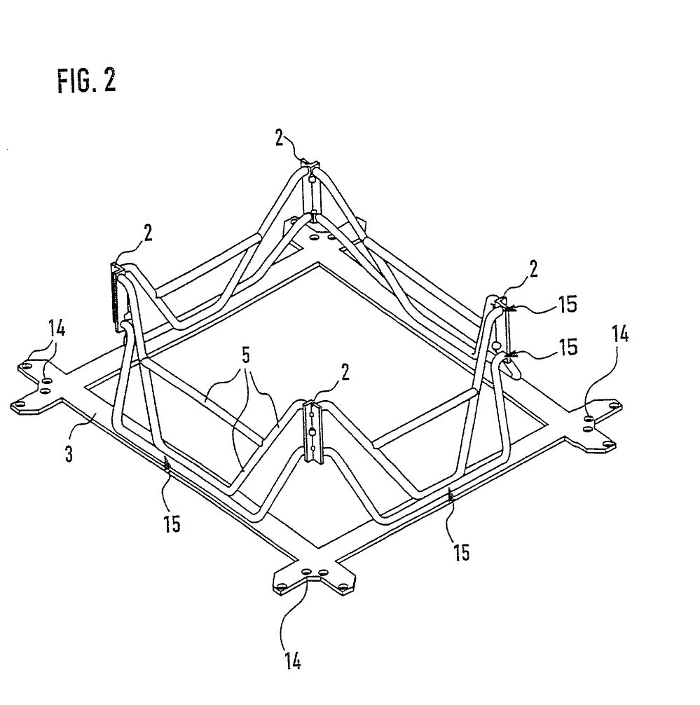

The frame profile serving as sliding pad holder is shown in FIG. 2 as viewed from underneath.

The bracings formed on the underside of the sliding pad holder 3 that essentially extend over the longitudinal side of the frame profile are connected to each other at their corner points via corner elements. The sliding pads 2 represent the corner elements and are enclosed by the sliding pad guides 4 (refer to FIG. 1). Extensions that nearly form a right angle are formed at the corner points of the sliding pad holder 3, in which holes 14 are provided. The sliding pad holder 3 is connected to the spindles of the four geared motors 8 via the holes 14. The bracing structure 5 that strengthens the sliding pad holder 3 is welded to the corner elements forming the sliding pads 2 and is also connected to the underside of the sliding pad holder 3 via a welding joint.

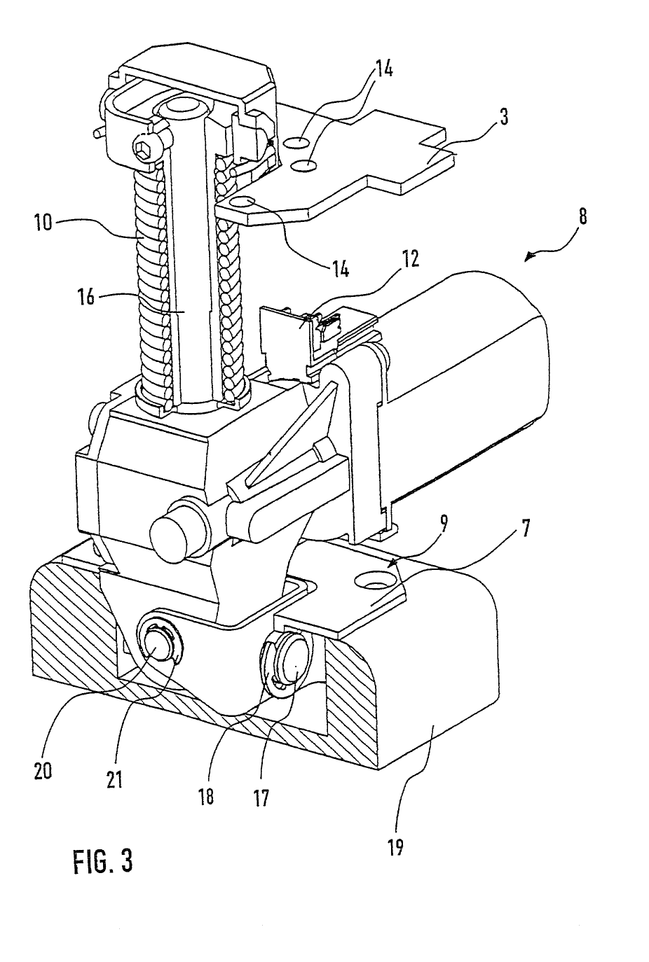

A sectional view of a lifting spindle geared motor with support and corner region of the sliding pad holder is shown in FIG. 3.

The geared motor 8 that starts a lifting spindle 16 rotating is provided with an electrical connection 12, with which the geared motor 8 can be connected to a power supply 23. A recess is provided in a support 19 on the bottom end of the geared motor 8, in which the base plate 7 is placed. The base plate 7 is preferably screwed to the support 19. A first bolt 17 is provided in the hollow space provided in the support 19, which is provided with a retaining ring 18, and makes a first rotary motion of the lifting spindle geared motor 8 possible.

A further bolt 20 is provided in a U-shaped carrier enclosing the lower end of the spindle drive, which is secured with a retaining ring 21, by means of which a movement of the spindle drive around a second axis of rotation is made possible. A spindle 16 driven by the electric motor 8 is located in the top section of the lifting spindle geared motor 8, which spindle 16 is enclosed by a spring element 10. The spring element 10 is dimensioned so that it supports an upward movement of the sliding pad holder 3, which is only indicated here. To connect the sliding pad holder 3 with the lifting spindle geared motor 8 supporting the corner points in each case, holes 14 are provided in the frame profile forming the sliding shoe holder 3. In a fashion not shown here in greater detail, the top side of the spindle 16 of the lifting spindle geared motor 8 is screwed together with the corner points of the sliding pad holder 3.

FIG. 4 is a wiring diagram for a control of four geared motors that are assigned to support points of a vehicle seat substructure.

The control 24 is connected to a power supply 23, which can be formed by a voltage source in a motor vehicle, for example. The same is true for the four lifting spindle geared motors 8 represented on the right side of FIG. 4, to which voltage is also applied via a power supply 23, and that are connected to the ground of the motor vehicle via a ground connection 22.

A control of the corresponding lifting spindle geared motors can take place in the corners of the sliding pad holder via the control 24, whereby the control 24 includes a wiring system 25 as well as electronic components, preferably diodes. The electronic components in the form of diodes—arranged in groups in each case—are also connected to a ground via a ground connection 22. The vehicle seat can be positioned in any direction via the control 24 according to the arrows surrounding the control, and this can also take place independently of adjustment commands from the vehicle passengers; instead, it can take place automatically according to the respective driving situation of the motor vehicle.

FIG. 5 shows a seat surface of a vehicle seat supported by four rigid guide bars.

The seat surface 32 is accommodated in hinge points 29 by four rigid guide bars 28. The steel guide bars 28 are arranged in the form of two four-bar mechanisms standing at a slant to each other, which, in turn, form a trapezoidal shape relative to each other (refer to FIG. 6). They are accommodated on seat rails 27 extending longitudinally toward the seat surface 32 at the lower end of the steel guide bars 28. By means of this arrangement of the rigid guide bars 28, it is possible to determine the instantaneous center 30 (refer to FIG. 6), i.e., the point of rotation of the lateral motion around the longitudinal axis and the motion toward the front and back around the transversal axis that is current at that instant, on an individual basis. The point of rotation therefore moves in an instantaneous center field that is clearly located above the seat surface 32. The vertical axis, the longitudinal axis, and the transverse axis based on the seat surface 32 are indicated with dash-dotted lines in the drawing according to FIG. 5. The rigid guide bars are adjusted using the motor by means of two independently-actuatable adjusting units 38, 41 situated between the seat rails 27 and located below the seat surface 32.

FIG. 6 is a representation of the instantaneous center 30 occurring for the spherical seat adjustment with four steel guide bars according to FIG. 5.

The rigid guide bars 28 hinged in pivot points 29 on the seat rails 27 in each case form a four-ball mechanism, which, according to the representation in FIG. 5, are arranged slightly offset in relation to each other as viewed in the direction of the longitudinal axis of the seat surface 32. If one pictures the rigid guide bars 28 extending further upward, i.e., if the working lines are extended to the point of intersection, the instantaneous center 30 is identified. In the configuration according to FIG. 5, upon which FIG. 6 is based, the instantaneous center is located at a distance 33 above the seat surface 32. This has a favorable effect on the perception of the seat adjusting processes by the vehicle passenger sitting on the vehicle seat at the time.

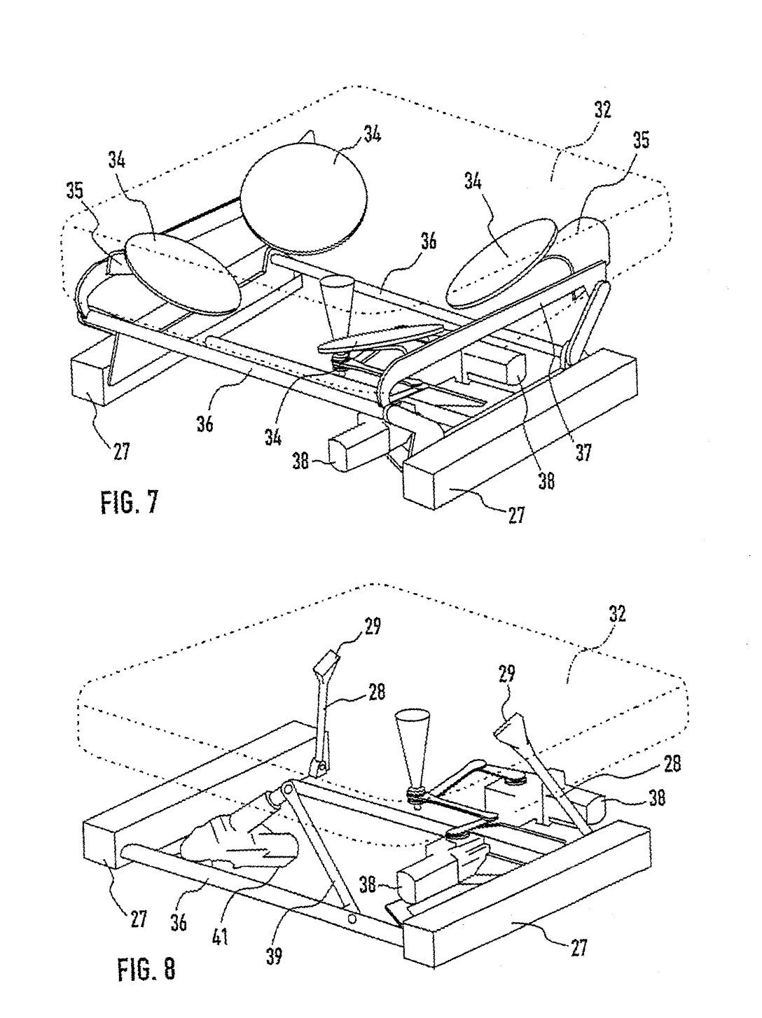

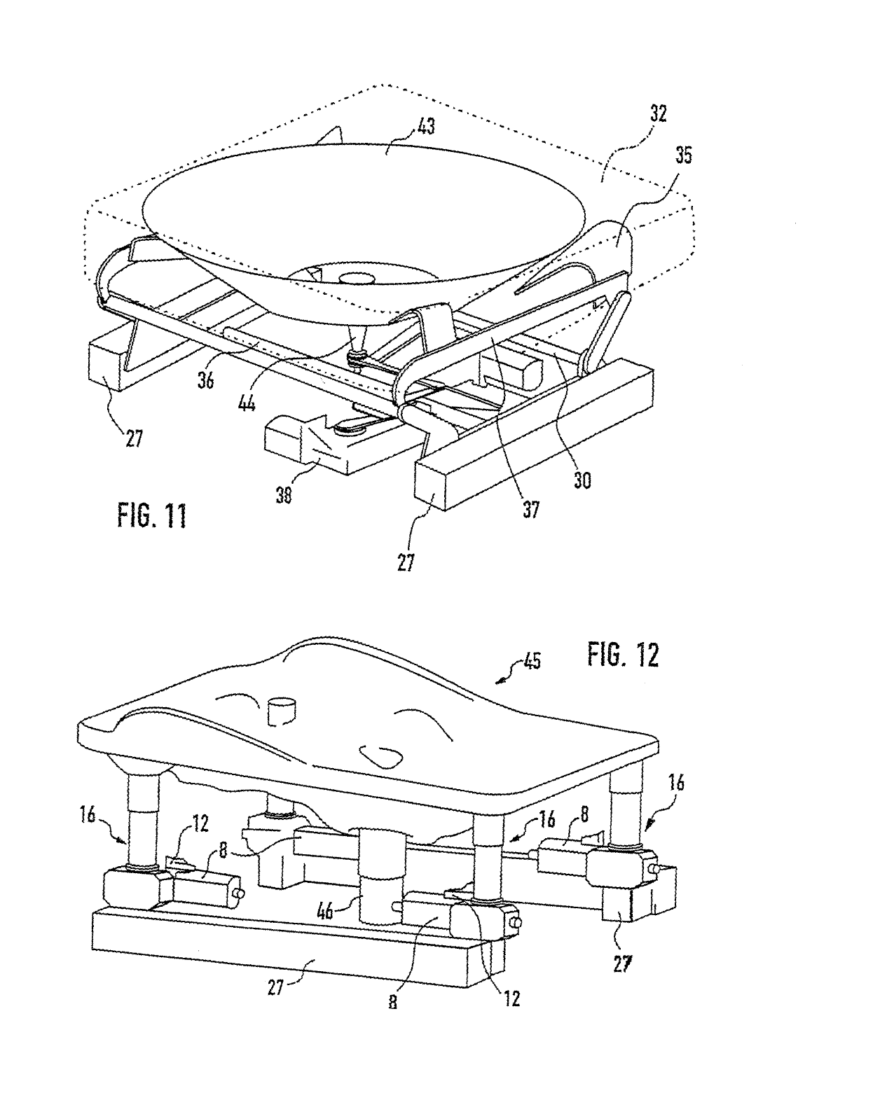

FIG. 7 shows a spherical seat adjustment with a ball cup-shaped element designed in the form of a pivoted link, supported in sliding cushions, and accommodating the vehicle seat. In this variant of the embodiment of a spherical seat adjustment 1, the seat surface 32 of a vehicle seat is provided with a ball cup segment 43 (refer to FIG. 11) that is not shown in the representation according to FIG. 7. This ball cup segment 43 is supported by three or, preferably, four sliding cushions 34. The sliding cushions can have the circular shape shown, or they can be laterally connected with each other, or they can be designed rectangular or square in shape, and each one is secured to mounting elements 35 that, in turn, are secured to rails. The rails on the seat 37 are secured to the seat rails 27 located on the vehicle floor via levers supported in hinged fashion, whereby the rails 37 can be connected to each other via crossbars 36. The sliding cushions 34 effect an improved friction behavior between the ball cup-shaped segment 43 below the seat surface 32. The seat surface 32 of the vehicle seat can tilt around the longitudinal axis, and a tilting motion of the seat surface 32 of the vehicle seat around its transversal axis is possible. In this exemplary embodiment, individual steel guide bars and steel guide bars connecting them can be eliminated entirely. The variant of the embodiment makes it possible, in advantageous fashion, to define a fixed point of rotation of the seat surface 32 of the vehicle seat to be adjusted spherically. Two adjusting drives 38 and 41 are accommodated under the seat surface 32 between the seat rails 27, each of which acts on one of the crossbars 36 and effects an adjustment of the rails 37 on the seat.

The representation according to FIG. 8 shows a spherical seat adjustment with two rigid guide bars in the rear section of a vehicle seat, and a third movable guide bar in its front section.

Rigid guide bars 28 are hinged in the rear section of seat rails 27, which are connected to the vehicle floor. The rigid guide bars 28, in turn, are connected via their top ends to the seat surface 32 of the vehicle seat in hinge points 29. In this variant of a spherical seat adjustment 1, an anterior, movable third guide bar 39 is provided with its own adjusting unit 41. Using this adjusting motor system 41, it is possible to rotate the seat surface 32 of the vehicle seat laterally at its upper hinge points 29 toward a vehicle door, for example, in order to make it easier for the vehicle passengers to get in and out of the car. Depending on the driving situation, a rotation of the seat surface 32 of the vehicle seat can also take place in dependence on the current driving situation. In this variant of the embodiment of the spherical seat adjustment 1, each of the rear rigid guide bars 28 is assigned to two adjusting units 38 that can be actuated independently of each other. According to this spherical seat adjustment 1, the seat surface 32 of the vehicle seat can be tilted around its longitudinal axis, and a tilting motion of the seat surface 32 around the transverse axis is possible, whereby, in this variant of the embodiment, only three guide bars, a movable guide bar 39 and two steel guide bars 28 in the rear section are required. A spherical adjustment of the vehicle seat that is quasi static and the dynamic adjustment of the vehicle seat depending on the driving situation can be separated from each other, whereby a clutch for the rotation around the vertical axis of the seat surface 32 of the vehicle seat is not required.

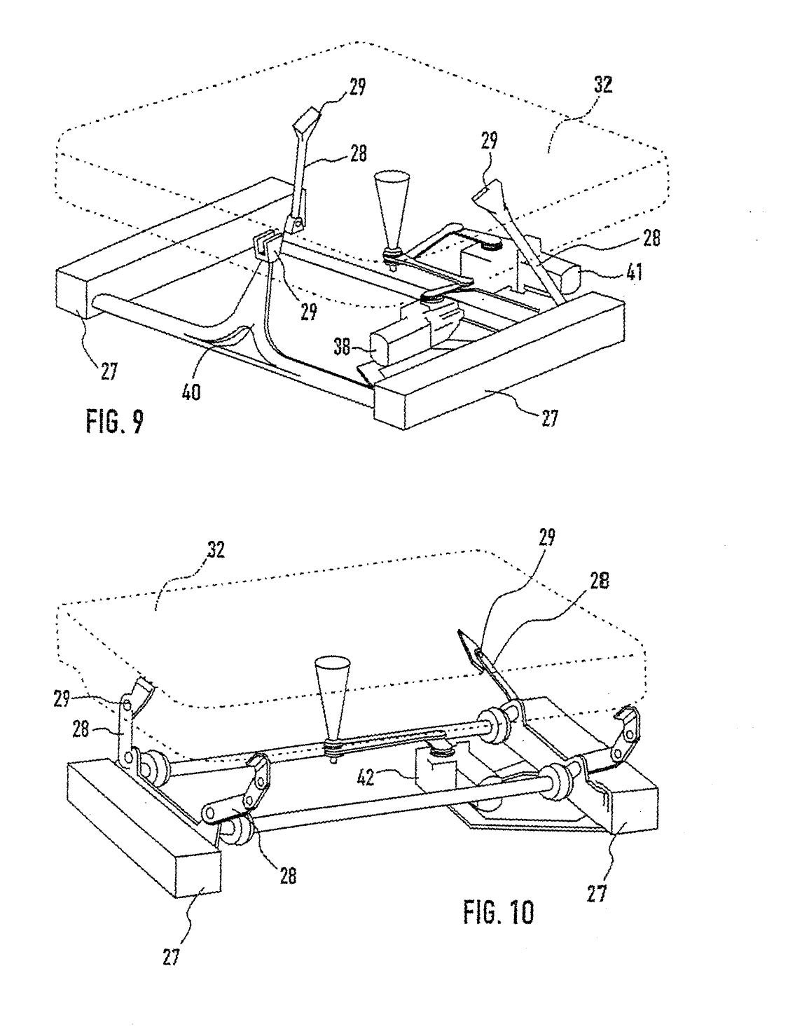

A spherical seat adjustment with three rigid guide bars is shown in FIG. 9, whereby the rigid guide bars 28 located in the rear section of the seat surface 32 and the anterior guide bars 40 are hinged in hinge points 29 under the seat surface. In this variant of the embodiment of a spherical seat adjustment, the two anterior rigid guide bars 28 were replaced with a single anterior guide bar 40. Due to the lower hinging of the anterior guide bar 40, an instantaneous center of revolution occurs, which is markedly lower than the instantaneous center of revolution formed by the two rear rigid guide bars 28. As a result, a momentary axis of rotation forms that [verb missing?] at a slant from the middle seat back height, i.e., the intersection of the two rear imagined extensions of the rigid guide bars 28 up to the anterior point of rotation of the seat surface 32 [verb?]. When a lateral adjustment is performed, the slanted axis of rotation also forces the seat surface 32 of the vehicle seat to make a supporting rotation around the vertical axis. The adjustment via the motor can take place by means of two adjusting units 38 and 41 located between the seat rails 27. In this configuration as well, the rigid guide bars are connected to this in hinged fashion in hinge points under the seat surface 32, and the same applies for the anterior guide bar 40, which is also hinged underneath the seat surface 32 of the vehicle seat in the hinge point 29.

A spherical seat adjustment 1 with a seat underbody hanging at a slant is shown in FIG. 10.

In this variant, a motion of the seat surface 32 of the vehicle seat around its transverse axis is prevented. The two rigid guide bar configurations 28 situated parallel to each other are tilted, as five-bar mechanisms, toward their longitudinal axis in such a fashion that the imagined extensions of the plane mechanisms formed out of rigid guide bars 28 and arranged at an angle in relation to each other intersect in an instantaneous center line over the seat surface 32 of the vehicle seat, comparable to the configuation according to FIGS. 5 and 6. An adjusting unit 42 is provided under the seat surface 32 of the vehicle seat, which contains a lifting spindle geared motor 8 according to the preceding description. The five-bar mechanisms formed out of rigid guide bars 28 and positioned at an angle to each other are connected to each other via crossbars, whereby each of the rigid guide bars 28 can be secured to seat rails 27 accommodated on the vehicle floor.

FIG. 11 shows a spherical adjustment of a vehicle seat having a ball cup segment designed in the form of a pivoted link.

The ball cup 43 located under the seat surface 32 can be composed of a material having a low friction coefficient and is preferably supported on mounts 35. The mounts are secured to rails 37 on the seat surface 32 which, in turn, are connected to each other by means of crossbars 36. The ball cup segment 43 designed in the form of a pivoted link can also be accommodated on sliding cushions 34 as shown in FIG. 7 which, in turn, rest on the mounting elements 35. The point of rotation of the seat surface 32 is firmly defined in a point that can be identified by the cone 44 indicated in the drawing. The seat surface 32 can be rotated around the cone 44 by means of the adjusting drive 38 located under the seat surface 32, which cone 44 extends in the direction of the vertical axis of the seat surface 32 of the vehicle seat.

Finally, a spherical seat adjustment according to the 4-column principle is shown in the representation according to FIG. 12.

In this configuration it is apparent that geared motors 8 driving lifting spindles 16 in each case are accommodated on the end points of the seat rails 27 connected to the vehicle floor of the passenger compartment. Each of the geared motors 8 has an electrical connection 12, via which they can be connected to a power supply. Moreover, a central force transduction 46 can be located under the seat underbody 45 in the middle between the seat rails 27. By means of the central force tranduction 46 under the seat underbody 45, the lifting spindles can be relieved of the weight of the vehicle seat and the person sitting on it, by way of which a longer life of a spindle drive transferring a rotary motion and producing an adjusting motion can be achieved. Signs of wears occurring as a result of the load alternation and noise generation can therefore be effectively suppressed. By means of the arrangement of the spindle drives 16 at the corners of the seat underbody 45, a height adjustment apparatus to be provided as well can be eliminated completely.

### Reference Numerals

| | |
|---|---|
| 1 | Spherical seat adjustment |
| 2 | Sliding pad |
| 3 | Sliding pad holder (frame profile) |
| 4 | Sliding pad guide |
| 5 | Bracing |
| 6 | Guide plate |
| 7 | Base plate |
| 8 | Geared motor |
| 9 | Screwed connection |
| 10 | Spring element |
| 11 | Stop |
| 12 | Electrical connection |
| 13 | Screwed connection |
| 14 | Bore hole |
| 15 | Welding joint |
| 16 | Lifting spindle |
| 17 | Bolt |
| 18 | Retainer ring |
| 19 | Support |
| 20 | Bolt |
| 21 | Retainer ring |
| 22 | Ground |
| 23 | Power supply |
| 24 | Positioning control |
| 25 | Wiring system |
| 26 | Electronic component |
| 27 | Seat rail |
| 28 | Rigid guide bar |
| 29 | Hinge point |
| 30 | Instantaneous center |
| 31 | Trapezoid |
| 32 | Seat surface |
| 33 | Distance between instantaneous |
| | center and seat surface |
| 34 | Sliding cushion |
| 35 | Mounting element |
| 36 | Traverse |
| 37 | Rails on the seat |
| 38 | Adjusting unit |
| 39 | Movable third guide bar |
| 40 | Anterior guide bar |
| 41 | Adjusting unit |
| 42 | Adjusting mechanism |
| 43 | Ball cup segment |
| 44 | Cone |
| 45 | Seat underbody |
| 46 | Central force transduction |

1. Apparatus for adjusting a vehicle seat, the position of which can be adjusted via one or more geared motors (8, 38, 41, 42), wherein the geared motors (8, 38, 41, 42) can be actuated via a control (24), characterized in that a vehicle seat underbody (3, 32, 45) is supported at at least three points by means of support components (16; 28, 29, 40; 34, 35, 43), and at least one support point (16, 29, 34) can be varied relative to the other remaining support points of the vehicle seat in such a fashion that a spherical seat adjustment results.

2. Apparatus according to claim 1, characterized in that two support components (16; 28, 29, 30; 34, 35, 43) lying one behind the other as viewed in the longitudinal direction of the seat surface (32) can be controlled at a time by means of the control (24).

3. Apparatus according to claim 1, characterized in that two support components (16; 28, 29, 30; 34, 35, 43) lying next to each other as viewed in the transverse direction of the seat surface (32) can be controlled at a time by means of the control (24).

4. Apparatus according to claim 1, characterized in that driven support components designed in the shape of a ball socket (43) or as a sliding cushion (34, 35), to which a common adjusting unit (38) is assigned, rotate the seat surface (32) of the vehicle seat.

5. Apparatus according to claim 1, characterized in that a sliding pad holder (3) supporting the vehicle seat is outfitted with sliding pads (2) that can be moved in sliding pad guides, the upper end position of which is limited by a stop (11).

6. Apparatus according to claim 1, characterized in that two four-bar mechanisms composed of steel guide bars (28) are located under a vehicle seat, are slanted in relation to each other, and can be actuated by means of a common adjusting unit (38), wherein the instantaneous center (30) is located at a distance (33) above the seat surface (32).

7. Apparatus according to claim 1, characterized in that the vehicle seat is supported in the rear section by two rigid guide bars (28) positioned at a slant relative to each other and by an anterior guide bar (40) located in a lower position, wherein a rotary motion proceeding at a slant and supporting a lateral adjustment of the seat surface (32) of the vehicle seat is produced.

8. Apparatus according to claim 7, characterized in that one separate adjusting unit (38, 41) each is assigned to the anterior guide bar (40) and the rear rigid guide bars (28).

9. Apparatus according to claim 1, characterized in that a separate adjusting unit (41) is assigned to a movable anterior guide bar (39) that makes a rotary motion of the seat surface (32) of the vehicle seat toward the vehicle door possible.

10. Apparatus according to claim 1, characterized in that an adjusting pivoted link (43) designed in the shape of a ball cup is supported by sliding cushions (34) that are supported on mounting elements (35) that [verb missing] on support rails (37) that can be positioned by means of an adjusting unit (38).

11. Apparatus according to claim 1, characterized in that the adjusting pivoted link (43) designed in the shape of a ball cup is directly supported by positionable mounting elements (35).
